(19) United States
(12) Patent Application Publication
(10) Pub. No.: US 2005/0131821 A1
(43) Pub. Date: Jun. 16, 2005

(54) System for controlling cash transactions with customers within banking institutes

(76) Inventor: Karl-Heinz Eberhardt, Pahl (DE)

Correspondence Address: JENKINS, WILSON & TAYLOR, P. A., 3100 TOWER BLVD, SUITE 1400, DURHAM, NC, 27707, US

(21) Appl. No.: 10/969,285

(22) Filed: Oct. 20, 2004

Related U.S. Application Data
(63) Continuation of application No. 09/743,583, filed on Jan. 11, 2001, now abandoned.

(30) Foreign Application Priority Data
Jul. 13, 1998 (DE) 19831360.8
Aug. 24, 1998 (DE) 19838437.8

(51) Int. Cl. G06F 17/60

(52) U.S. Cl. 705/42; 705/43

(57) ABSTRACT

System for Controlling Cash Transactions With Customers Within Banking Institutes. According to one embodiment, a system is provided for carrying out cash transactions with customers within financial institutions, their branches and the like. The system can include a customer identification device designed to record customer-specific information. In addition, the system can include an input point for identifying the customer and for describing a cash-issuing transaction. Further, the system can include a cash-issuing device. The system can also include at least one data processing device for controlling the cash-issuing device as a function of input signals which are generated or prepared by the first customer identification device, by the input point, and by a data source.

The invention relates to a system for carrying out cash transactions with customers within financial institutions, their branches and the like.

It is generally known that in financial institutions, on the one hand, open customer counters with workstations occupied by employees of the financial institution and, on the other hand, cash desks are made available for cash transactions with customers and in said customer counters and cash desks the cashier is provided with a workstation which is provided, in accordance with the regulations of the occupational accident insurance associations, with full bullet-proof glazing and a suitable lock system. When a business transaction is carried out at the customer counter, so the customer can be issued with a cash counter number which corresponds to a place card and which is also provided on a voucher which is forwarded from the customer counter to the cash desk. The customer who presents himself to the cash desk then has the cash paid out to him on showing his cash desk number, which corresponds to the voucher.

In the last few years, in the service area of main offices and larger branches of financial institutions, cash transactions with customers have been transferred to automatic cash machines which have been installed in or near to the customer counters and which have given rise to considerable expenditure on equipment.

In small and very small branches, the respective accident prevention regulations and the guidelines of the Central Bank Committee (ZKA) and the occupational accident insurance associations require full safety glazing for the cash desk, which makes costly investments necessary and does not contribute to good service conditions.

In the last few years, ATMs which are installed in the vicinity of financial institutions or their branches or even within the business premises of the financial institutions and which are controlled by inputting information using check cards assigned to a customer or using a customer-activated keypad and by a data network and/or by data processing devices of the financial institution, and issue an amount of cash specified by the customer, within a limit have become widespread.

The invention is intended to solve the object of designing a system for carrying out cash transactions with customers within financial institutions, their branches and the like, in such a way that cash transactions can be carried out with comparatively little expenditure on equipment, while dispensing with the need for cash desks provided with full glazing and without the customer having to be provided with particular knowledge and abilities in order to carry out these transactions. The intention is to achieve efficiency and saving effects thanks to multiple use of devices which are generally already provided.

This object is achieved according to the invention by means of the features specified in the appended claim 1.

Advantageous refinements and developments are the subject-matter of the claims following claim 1, their contents being the subject-matter of the present specification, without individually repeating their contents at this point.

It is to be considered particularly advantageous that systems of the type specified here can also be set up using ATMs which are already present in financial institutions with their equipment being supplemented to a comparatively small degree.

Cash desks occupied by an employee of the financial institution, and the full bullet-proof glazing of such cash desks, can be eliminated. According to the principles specified here, an ATM which is often already present can be put to an additional use.

Relatively large self-service foyers in conjunction with ATMs installed in their vicinity can remain open longer than very small branches and nevertheless comply fully with the relevant accident prevention regulations and the requirements of the Central Bank Committee (ZKA) and of occupation accident insurance associations.

Exemplary embodiments are explained in more detail below with reference to the drawing, in which;

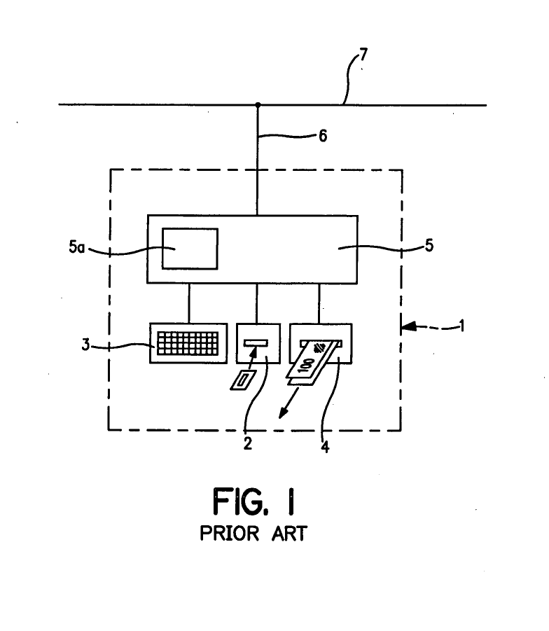

FIG. 1 shows a schematic, highly simplified view of an ATM of a known type, this view also serving to define the terms;

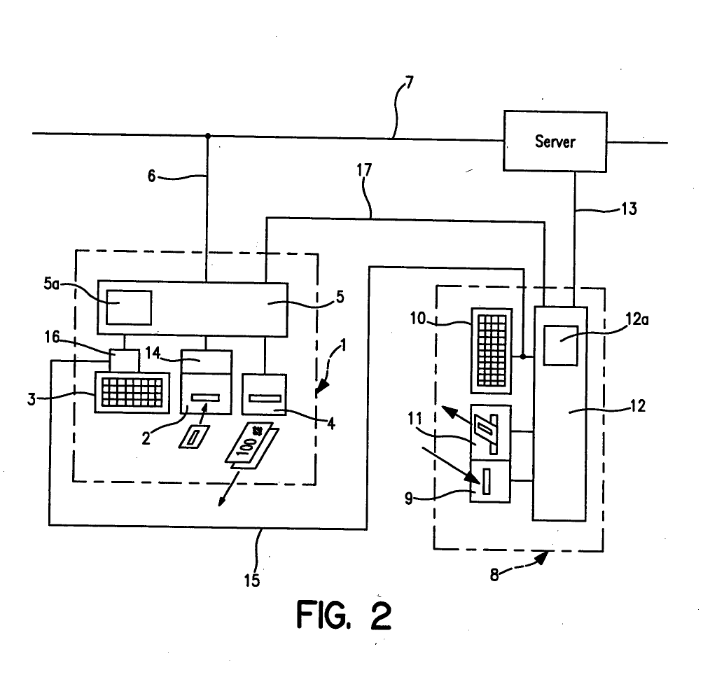

FIG. 2 shows a schematic circuit diagram, simplified for the sake of easier comprehension of a system of the type specified here, relating to the application of the invention in small branches,

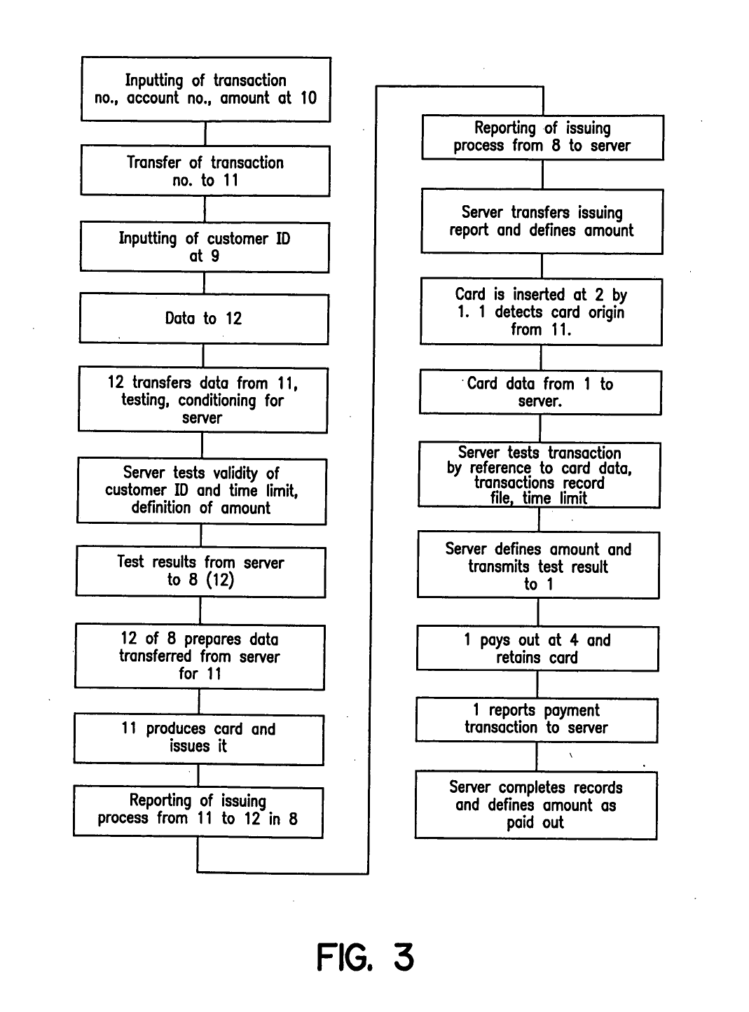

FIG. 3 shows a flowchart of a business transaction in the system according to FIG. 2,

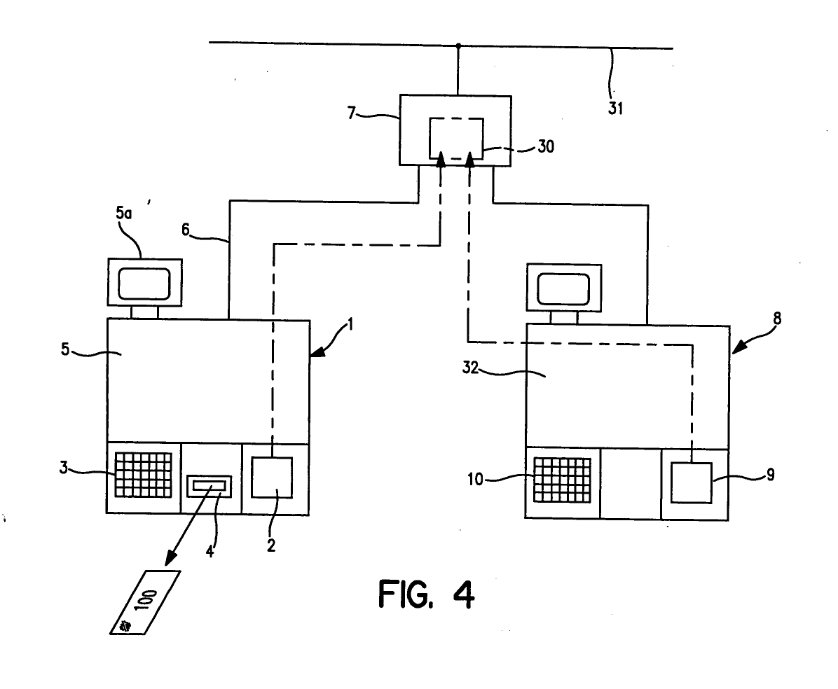

FIG. 4 shows a schematic circuit diagram, simplified for the sake of easier comprehension, of a further exemplary embodiment of a system of the type specified here, a comparison of the customer identification taking place at the location of a server;

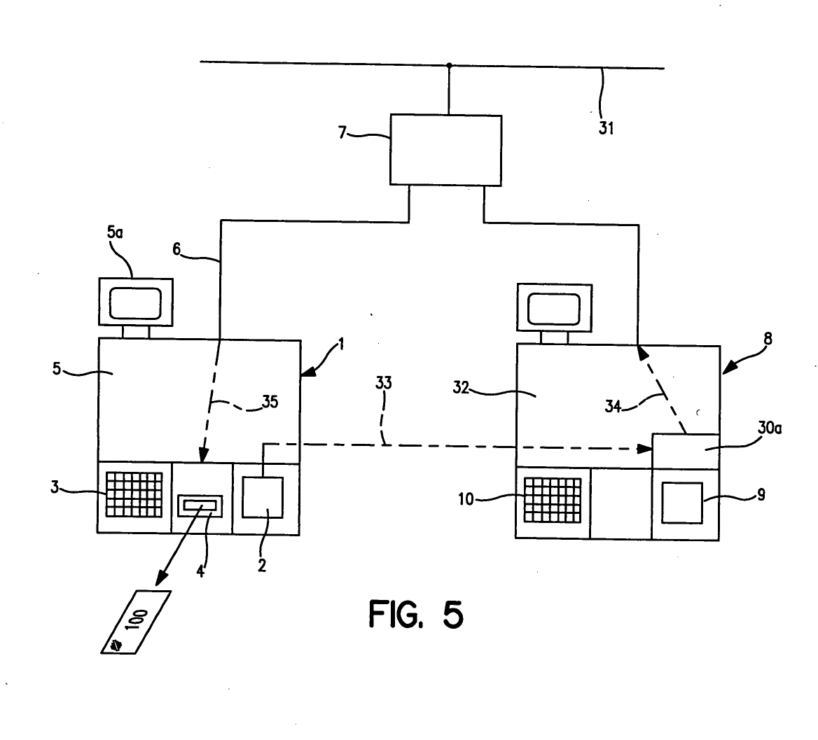

FIG. 5 shows a schematic, simplified view of a system according to another embodiment, the comparison of customer identifications taking place at a workstation which is occupied by an employee;

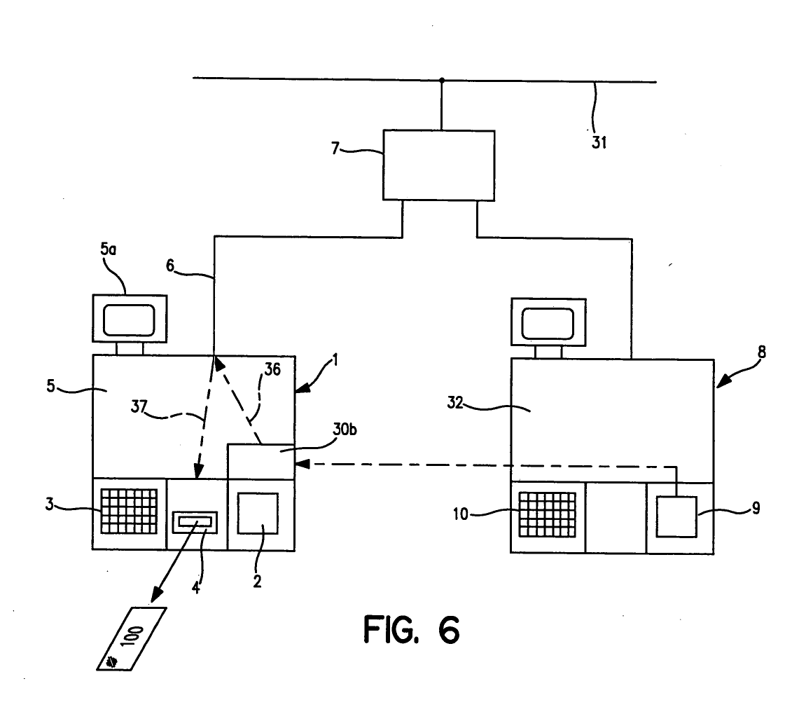

FIG. 6 shows a schematic, simplified view of a system according to yet another embodiment in which a comparison of customer identifications takes place at the location of a point at which cash-issuing transactions are carried out, in particular an ATM; and

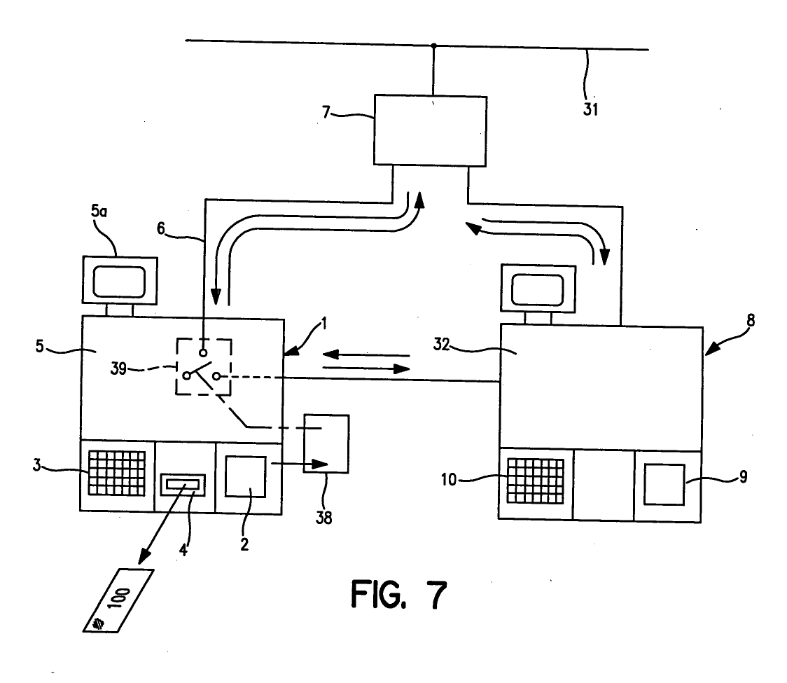

FIG. 7 shows a schematic, simplified circuit diagram of a system of the type specified here, in accordance with an exemplary embodiment in which the data traffic of an ATM using a server is switched over from direct data exchange to data exchange via a workstation occupied by an employee.

In FIG. 1, a conventional ATM is indicated by means of a dot-dash outline. This ATM is installed in or near to a financial institution, a branch or some other frequented location, for example a railway station or a supermarket. The ATM contains a customer identification device into which a check card provided with a magnetic strip is inserted by the customer, said check card forming an information carrier which is assigned to the respective customer and the information which identifies the customer being, for example, a password which is stored on the information carrier and which has a specific relationship with a secret number which is personally known to the customer exclusively. It is to be noted here that the unit which is referred to above as a customer identification device is in the strictest sense of the prior art merely a check card identification device.

The ATM 1 also contains a keypad 3 as input point. At this keypad, the customer enters his secret number and describes a desired cash-issuing transaction by manually entering the amount he wishes to have paid out, at the keypad.

Furthermore, the ATM 1 contains a cash-issuing device 4 which generally issues notes which in a satisfactory cash-issuing transaction generally issues notes in a combination corresponding to the desired amount entered manually. In addition, inside the ATM 1 there is a device 5 for controlling the cash-issuing device 4 as a function of input signals which are generated or prepared by the customer identification device 2, by the input point 3 and by a data source. The device 5 can also be referred to in the wider sense as a data processing device, and, in the example of an ATM according to the prior art outlined in FIG. 1, it is connected via a data line 6 to an in-house data network 7 which is in turn connected to a data processing device, generally referred to as a server, of the respective financial institution, or to a plurality of such data processing devices.

The previously-described parts of a conventional ATM can also be found in a system of the type specified here. Accordingly, corresponding reference symbols are also used for such parts in FIG. 2.

Apart from the ATM 1, the system for carrying out cash transactions with the customers of the design specified here contains the workstation 8 occupied by an employee of the respective financial institution. In the present exemplary embodiment which relates to small branches, this workstation has a separate customer identification device 9 in the form of a password-inputting device. The customer identification device 9 can also be formed by a fingerprint sensor or by a signature scanner or by a voice analyzer. Devices 9 which operate according to other biometric methods may also be used here.

Furthermore, at the location of the workstation 8 there is an input keypad 10 similar to the input keypad 3 of the ATM 1. At the input point with the keypad 10, the employee of the financial institution carries out the identification of the customer, for example the inputting of his name, the inputting of the transaction number and the description of the cash-issuing transaction which is necessary for the account records.

A very important part of the workstation 8 is an information-carrier-writing apparatus 11, for example in the form of a magnetic-card-writing apparatus for producing customer-assigned information carriers.

The keypad 10 and the information-carrier-writing apparatus 11 are connected to a the data processing device 12 which is situated at the location of the workstation 8 and is connected via a data line 13 to the data network and to the data processing device which is referred to as a server.

Screens of the data processing devices 5 and 12 are indicated by 5a and 2a.

The procedure of a cash-issuing transaction (of a small branch in the example selected) is, from the customer's point of view, as follows:

Firstly, the customer goes to the customer counter which is equipped with the workstation 8. There, the employee of the financial institution inputs, at the keypad 10, for example the customer's name, a transaction number and the details of the cash-issuing transaction, in particular the customer's account number and the amount which is to be paid out. The customer identifies himself by means of his/her signature, by inputting a password or the like at the customer identification device 9 or, in a modification thereof, by means of an additional input at the keypad 10, which cannot be viewed by the employee of the financial institution.

In the present exemplary embodiment, the customer then receives a magnetic card from the information-carrier-writing apparatus 11.

The customer then goes to the ATM 1 with this magnetic card and inserts it into the customer identification device 2. The customer does not need to make an additional keypad input at the keypad 3 because, in contrast to the conventional method of operation of the ATM 1, the cash-issuing device 4 is triggered solely by the insertion of the magnetic card into the customer identification device 2, provided that the respective magnetic card originates from the magnetic-card-writing apparatus 11 of the workstation 8 and is detected as such a card by the device 2 on the basis of a particular identification.

After the desired amount of cash has been paid out at the cash-issuing device 4, in the example given here the customer's magnetic card is deleted by the customer identification device 2 and retained by the ATM 1. For this purpose, in the embodiment according to FIG. 2, a card-deleting device 14 is assigned to the customer identification device 2 of the ATM 1.

In particular, the employee of the respective financial institution prepares, according to the customer's instructions, the cash-issuing transaction at the location: of the workstation 8 on the keypad 10 in a dialogue with the device 12 using the information stored in it or the information obtained from the network 7 via the data line 13, and causes appropriate control commands to be transmitted to the device 5 of the ATM 1, either via the data line 13, the network 7 and the data line 6 or by means of a data line 17 leading directly from the device 12 of the workstation 8 to the device 5 of the ATM 1.

According to a modified embodiment, the preparation of the payment at the ATM 1 can also be prepared by the employee of the financial institution from the workstation 8 by virtue of the fact that the keypad 10, instead of the keypad 3, controls the device 5 via a separate control signal channel 15 and a switch 16.

It is significant that, ultimately, data stored on the information carrier output by the information-carrier-writing apparatus 11 do not describe in any way the respective cash-issuing transaction, but rather the data cause the ATM 1 to pay out only if the ATM 1 has at the same time been prepared to make a payment on an in-house basis by the employee of the respective financial institution from the workstation 8. To this end, the ATM 1 is coupled to the server and to the workstation 8 via data-transmission paths, often referred to as a so-called token ring. This provides the necessary protection against manipulation.

An additional protection against manipulation and fraud is provided by the use of suitable sensors and signal transmitters at the information-carrier-writing apparatus 11 of the workstation 8 to generate a confirmation signal when the information carrier is issued to the customer, said confirmation signal being transmitted from the workstation 8 to the ATM 1 via the data line 13, the network 7 and the data line 6, for example and opening a time window in it which is closed again after a certain, adjustable time. The device 5 waits only within this time window and, when the particular information carrier in question is received at the customer identification device 2, the device 5 causes the cash to be issued at the cash-issuing device 4. By logically linking part of the information On the information carrier to time control signals to a group of signals to be transmitted from the device 12 to the device 5, it is possible to ensure that staggered time windows are opened specifically for customers successively using the ATM 1 after going to the customer counter.

In addition, the identification of the information carriers which are issued by the workstation 8 ensures that such information carriers actuate the ATM 1 without the keypad 3 being operated, while the ATM 1 can continue to be used for customary issue of cash with a check card using the keypad 3. To this end, an appropriate card sensor, which initiates switching transactions at the ATM 1 is provided.

The flowchart from FIG. 3 shows an example of a sequence of steps of a transaction in a system constructed according to FIG. 2.

The data of the transaction are input by the employee of the financial institution using the keypad 10, this data comprising the number of the transaction, the customer's account number and the amount which is to be paid out. In the next step, the number of the transaction is transferred to the magnetic-card-writing apparatus 11.

If the system is in a very small branch, the customer identification takes place electronically at the apparatus 9 when requested accordingly by the employee of the financial institution.

In the next step, the input data of the transaction, the password data and data from the magnetic-card-writing apparatus 10 are available at the device 12. They are conditioned there and transmitted to the server.

At the server, the validity of the password, predefined time limits and the identification of the amount of money are checked.

The result of the check is transmitted to the workstation 8.

The workstation 8 in turn transfers all the data from the server and prepares it for the magnetic-card-writing apparatus 11 which writes to the magnetic card and issues it and signals this issuing process to the device 12 of the workstation 8, which in turn informs the server of the issuing of the card.

In the next step, after reception of the message relating to the issuing of the card, the server defines the amount to be paid out.

The customer or the employee of the financial institution inserts the magnetic card, which has been written to by the magnetic-card-writing apparatus, into the device 2 of the ATM 1.

The device 2 checks whether the inserted magnetic card is a card which has been produced by the magnetic-card-writing apparatus 11 and reads the information content of the card.

Then, the ATM 1 transmits the read information to the server, where the validity of the transaction is checked by reference to the read information from the magnetic card 1, the account record file and time limits which have been input.

The server defines the amount which is to be paid out and transmits the information relating to the test result to the ATM 1.

Given a positive test result, the ATM 1 pays out and, retains the card, but in particular, firstly deletes its contents.

The ATM 1 finally reports the payment operation to the server, at which the payment is recorded and the paid-out amount is defined.

Apart from the ATM 1, the system for carrying out cash transactions with customers with the design specified here in accordance with FIG. 4 also contains the workstation 8 which is occupied by an employee of the respective financial institution.

While a single workstation 8 occupied by an employee and an associated point 1 at which cash-issuing transactions are carried out, in particular at ATM 1, are illustrated in FIGS. 4 to 7, the statements given above and also the appended claims may, of course, also apply to systems in which a plurality of workstations which are occupied by employees are assigned to a point at which cash-issuing transactions are carried out or to ATMS.

The system according to FIG. 4 contains, as does the ATM described with reference to FIG. 1, a customer identification device 2 at the location of the point 1 at which cash-issuing transactions are carried out, but this first customer identification device 2 differs from that of a conventional ATM, specifically from a conventional reading device or sensing device for an inserted check card, in that it is capable of not only carrying out such a conventional sensing or reading of a valid customer check card but, after a certain item of information has not been received or as a result of a specific item of information being received, it can be switched in such a way that the point 1 at which cash-issuing transactions are carried out (shown in FIG. 4) is transferred from the normal ATM mode into a specific mode dedicated to a specific customer of the workstation 8.

The first customer identification device 2 therefore contains the conventional sensing means of an ATM for carrying out the usual ATM mode in which the customer check cards and the inputting of code numbers determine the operating mode, as well as sensing means for recording customer-specific information for carrying out cash transactions in accordance with the concepts specified here. Such a customer identification device 2 records customer-specific information for a single processing operation of the cash transaction with the respective customer and may contain a password input device or a fingerprint sensor or a signature scanner or a voice analyzer or a device which operates according to other biometric methods. The aforesaid first customer identification device 2 can dispense with sensing devices for reading a usual check card if the system specified here is not designed to be equipped with a conventional ATM.

By analogy with the conditions at the point for carrying out cash-issuing transactions, at the location of the workstation 8 which is occupied by an employee there are an input keypad 10 and a second customer identification device 9, which customer identification device 9 is designed, like the first customer identification device 2, to record customer-specific information and can be implemented by a password input device or a fingerprint sensor or a signature scanner or a voice analyzer or a device which operates according to some other biometric method. In all cases, the identification method in the first customer identification device 2 corresponds to the respective method in the customer identification device 9.

In the embodiment according to FIG. 4, the identification results are fed to a comparator 30 within a data processing device or within the server 7 via separate signal lines (identified in FIG. 4 as dot-dash lines).

The comparator 30 tests whether the customer-specific information input into the first customer identification device 2 and the customer-specific information input into the second customer identification device 9 of the workstation 8 are identical to one another. Only if this is the case, is the cash-issuing device 4 enabled, after preparation of the payment transaction from the workstation 8 in cooperation with the data processing device 7, enabled for a prepared payment transaction at the point 1 at which cash-issuing transactions are carried out.

In the embodiment of the system specified here which is illustrated schematically in FIG. 4, it is therefore not necessary for a customer-identifying information carrier to be produced at the workstation 8, read at the point 1 at which cash-issuing transactions are carried out, retained and/or deleted. Instead, in the system according to FIG. 4, it is possible to submit one and the same customer-specific information carrier both to the device 9 and subsequently to the device 2 so that then, given a successful comparison in the comparator device 30, the point 1 at which cash payments are carried out, in particular the ATM, is enabled, from the server 7, specifically for the respective customer and for the implementation of the respective payment process, after which the customer either destroys his information carrier, which is specific to him, after using it at the system parts 8 and 1 or keeps it with him and can use it again; however, to use it again it is necessary to submit the information carrier in the customer identification device 9 of the workstation 9 and to carry out appropriate preparation operations at the input point 10 and via the server 7.

In FIG. 4, the customer identification devices 2 and 9 are specified exclusively as block symbols. In practical embodiments, the customer identification device at the location of the point at which cash-issuing transactions are carried out or at the ATM 1 is, in any case, designed so as to receive and sense normal check cards and to record other customer-specific information. This means that if the system component 1 is an ATM, at least the Customer identification device 2 contains a conventional check card reading device and, for example, a password inputting device or a fingerprint sensor or a signature scanner or a voice analyzer or a device which operates according to some other biometric method, as a component of the customer identification device 2, specifically a completely identical component to that which is also correspondingly found in the customer identification device of the workstation B.

The at least one data processing device which, in the case of the system specified here, is itself controlled by a positive comparison result of the comparator device 30 in FIG. 4 to the effect that the cash-issuing device 4 is enabled, in the embodiment according to FIG. 4 it is located in the server 7 in which the comparator device 30 itself is located. The server 7 can, as indicated in FIG. 4, be connected to a higher ranking computer via an in-house data line 31 or via some other network. This is not shown in the drawings in order to simplify the representation.

The data processing device which is controlled by a positive comparison result of the comparator device 30 to the effect of enabling the cash-issuing device 4 can, however, also be formed by the data processing device 5 of the point at which cash-issuing transactions are carried out, or the ATM 1, or can be implemented by means of a data processing device (designated by 32) of the workstation 8 which is occupied by an employee.

FIG. 5 shows a modified embodiment in which the result of the recording of a customer-specific item of information is transferred from the first customer identification device 2 of the point at which cash-issuing transactions are carried out, or the ATM 1, via a data transmission channel (indicated by a dot-dashed line 33), to a comparator device 30a of the workstation 8 which is occupied by an employee, and is compared there, specifically in the comparator device 30a, with the result of the recording of a customer-specific item of information by the second customer identification device 9. The comparison result can then be brought about either automatically or by appropriate inputting by the employee of the financial institution, transmitted to the server 7 and initiates the enabling of the cash-issuing device 4 at the point at which cash-issuing transactions are carried out, or the ATM 1. This transaction is indicated in FIG. 5 by the dot-dashed arrows 34 and 35.

FIG. 6 shows an embodiment in which the comparison of the results of the recording of customer-specific information in the customer identification devices 2 and 9 does not take place at the location of the workstation 9 which is occupied by an employee, but rather at the location of the point 1 at which cash-issuing transactions are carried out, in a comparator device 30b. The latter signals the comparison result via the data line to the server 7 which then in turn brings about the enabling of the cash-issuing device 4 in the event of a positive comparison result. This transaction is indicated by the dot-dashed arrows 36 and 37 in FIG. 6.

The embodiment according to FIG. 7 can basically be of the design of the embodiments according to FIGS. 4 to 6. In the embodiment according to FIG. 7, however, the point 1 at which cash-issuing transactions are carried out is, in any case, a conventional ATM, modified in order to implement the system of the type specified here.

In particular, the customer identification device 2, that is to say the device which performs both the sensing of usual check cards and responds to the inputting of a password or fingerprint or signature or voice sample, or to some other biometric input, is assigned a detector 38 which activates a switch 39 via suitable control signal sensors in such a way that whenever the detector 38 detects the inputting of a usual check card for normal removal of cash from the ATM 1, the switch 39 connects the data processing device 5 of the ATM 1 to the server 7 so that the normal, generally known operating mode of an ATM is ensured.

However, as soon as the detector 38 detects that customer-specific information which differs from a normal check card being input is input at the customer identification device 2, the detector 38 causes the switch 39 to be activated in such a way that a connection is set up between the ATM 1 and the workstation 8 which is occupied by an employee, with the result that the recorded results of the customer identification device 2 of the ATM 1 and the customer identification device 9 of the workstation 8 which is occupied by an employee are compared and, depending on the result of the comparison, the ATM 1 is caused to enable the cash-issuing device 4, specifically in accordance with the principles which are explained above with reference to FIGS. 4 to 6.

It is apparent that the system specified here is designed and can be used in such a way that an ATM which can be used in a conventional way can be switched to an individual operating mode which can be controlled directly or indirectly by a workstation occupied by an employee, in such a way that, for example, payment ran be made at the ATM although a customer account has already reached the credit limits if, for example, by submitting a check and requesting a check from another financial institution, the respective employee of the financial institution executing the transaction appears to be provided with sufficient security as to the identity of the customer.

The procedure for a cash-issuing transaction is, by analogy with the transactions described in conjunction with the embodiment according to FIG. 2, as follows:

The customer goes to the customer counter which is equipped with the workstation 8. There, the employee of the financial institution inputs, at the keypad 10, for example the customer's name, a transaction number and the details of the cash-issuing transaction, in particular the customer's account number and the amount which is to be paid out. The customer identifies himself at the customer identification device 9, or the employee of the financial institution does this for him/her, if appropriate using an identification means which has been issued on a temporary basis.

The customer is then instructed, or permitted, to make a corresponding input of an identification at the customer identification device 2, or the employee of the financial institution again does this for him.

A customer does not need to make an additional keypad input at the keypad 3 because the cash-issuing device 4 is, in contrast to the conventional method of operation of the ATM 1, prepared and initiated.

Finally, it is to be noted that the comparison of the results of the recording of customer-specific information by the first customer identification device and by the second customer identification device is preferably carried out only once and triggers the enabling of the cash-issuing device only once so that subsequent inputting of customer-specific information at the location of the point at which cash-issuing transactions are carried out will have no effect. However, the respective input information for customer identification is expediently kept stored at the location of the comparator device 30 or 30a or 30b in such a way that if a plurality of customers are served at a plurality of workstations which are occupied by employees, in the manner of the workstation 8, these customers can approach in any order the point at which cash-issuing transactions are carried out and receive payment.

1. A system for carrying out cash transactions with customers within financial institutions, their branches and the like,
having a customer identification device (2) which is designed to record customer-specific information;
having an input point (10) for identifying the customer and for describing a cash-issuing transaction;
having a cash-issuing device (4); and
having at least one data processing device (5, 7, 32) for controlling the cash-issuing device (4) as a function of input signals which are generated or prepared by the first customer identification device (2), by the input point (3, 10) and by a data source (7, 31);
characterized in that
the input point (10) or a further input point (10), for identifying a customer and for describing a cash-issuing transaction and in addition a second customer identification device (9), which is also designed to record customer-specific information, are arranged at the location of a workstation (8) which is occupied by an employee;
the aforesaid customer identification device (2) is arranged at the location of the processing station (1) for the cash-issuing transaction;
the results of the recording of a customer-specific piece of information by the first customer identification device (2) and by the second customer identification device (9) can be supplied to a comparator device (30, 30a, 30b); and
the at least one data processing device (5, 7, 32) is provided at the location of the workstation (8) which is occupied by an employee and/or at the location of the point (1) at which the cash-issuing transaction is executed and/or at a remote location (7; 31), and is controlled itself, to the effect that the enabling of the cash-issuing device (4), by a positive comparison result of the comparator device (30, 30a, 30b).

2. The system as claimed in claim 1, characterized in that the comparator device (30b) is situated at the location of the first customer identification device (2).

3. The system as claimed in claim 1, characterized in that the comparator device (30a) is situated at the location of the second customer identification device (9).

4. The system as claimed in claim 1, characterized in that the comparator device (30) is situated at the location of a remotely installed data processing device (7).

5. The system as claimed in one of claims 1 to 4, characterized in that the first customer identification device (2), a first input point (3), the cash-issuing device (4) and a first data processing device (5) are components of an ATM (1) which is known per se.

6. The system as claimed in one of claims 1 to 5, characterized in that the customer identification devices (2, 9) each respond to a password input, a fingerprint input, the inputting of an optically readable signature, a voice test input or to some other input which can be evaluated biometrically.

7. The system as claimed in claim 6, characterized in that the first customer identification device (2) is connected to a detector (38) which responds to a customer-specific information input which is different from a check card input, and activates a switch (39) which switches over the point (1) at which cash-issuing transactions are executed, formed by an ATM, from a connection to a server (7) or to a data network (31) to a connection to the workstation (8) which is occupied by an employee, and/or additionally sets up said connection.

8. The system as claimed claim 1, characterized
in that the input point (10) for preparing the point (1) at which cash-issuing transactions are executed is designed for paying out and, in addition, an information-carrier-writing apparatus (11) for producing customer-assigned information carriers is located at the location of the workstation (8) which is occupied by an employee, none of said information carriers containing data describing a cash-issuing transaction, and
in that the customer identification device (2) at the location of the point (1) at which cash-issuing transactions are executed is designed to read the information carriers produced by the information-carrier-writing apparatus (11), and these information carriers can be retained there and/or deleted after being detected and read.

9. The system as claimed in claim 8, characterized in that a first customer identification device (2), a first input point (3), the cash-issuing device (4) and a first data processing device (5) are components of an ATM (1) which is known per se.

10. The system as claimed in claim 8 or 9, characterized in that a password-inputting device or a fingerprint sensor or a signature scanner or a voice analyzer or a device which operates according to other biometric methods is situated at the location of the workstation (8) occupied by an employee as a specific customer identification device (9).

11. The system as claimed in one of claims 8 to 10, characterized in that the location of the workstation (8) which is occupied by an employee and the location of the point (1) at which cash-issuing transactions are carried out are connected via data lines (6, 7, 13) via which result signals corresponding to the comparison between certain of the aforesaid input signals, and additionally acknowledgement signals for confirming operating states of the customer identification device or devices (2; 9) and the cash-issuing device (4), and timing control signals, in particular time window signals for specifying time limits for the execution of processing time periods of the respective business transaction, can be transmitted.

12. The system as claimed in claim 9, characterized in that the customer identification device (2) of the ATM (1) is designed such that it deletes (14) and/or retains information carriers which are written to by the information-carrier-writing apparatus (11) of the workstation (8) which is occupied by an employee, on the basis of a particular identification of the same after their evaluation.

13. A method for processing a cash-issuing transaction using a payment device which is installed within financial institutions, their branches and the like and which contains a customer identification device for recording customer-specific information, an input point for identifying the customer and for describing a cash-issuing transaction, a cash-issuing device and a connection to a data processing device for controlling the cash-issuing device as a function of input signals which are generated or prepared by the customer identification device, by the input point and by a data source, in particular using an ATM,
characterized
in that data corresponding to a customer account, an amount which is to be paid out and, independently thereof, customer-identifying data, are input at the location of a workstation which is occupied by an employee and which is equipped with an input point,
in that the customer-identifying data are tested and the data relating to the amount which is to be paid out are tested by means of a transactions record file, in the or in a data processing device which is provided at the location of the workstation occupied by an employee and/or at the location of the point at which cash payment transactions are executed and/or at a remote location,
in that the test result and the data corresponding to the amount which is to be paid out are transmitted to the payment device,
in that, in turn, the customer-identifying data are input into the payment device, at its input point,
in that the correspondence between the latter data and the customer-identifying data which are input at the workstation which is occupied by an employee is checked, and given a positive check result, the payment is initiated, and
in that account records are processed (3) in the or a data processing device.

14. The method as claimed in claim 13, characterized in that the customer-identifying data which are input at the payment device are transmitted to the data processing device and compared there with the customer-identifying data which are input at the workstation which is occupied by an employee, and in that in the case of a positive result, the payment at the payment device is controlled from the data processing device.
